(19) United States
(12) Patent Application Publication
(10) Pub. No.: US 2022/0277050 A1
(43) Pub. Date: Sep. 1, 2022

(54) IDENTIFYING SEARCH TERMS BY REVERSE ENGINEERING A SEARCH INDEX

(71) Applicant: Microsoft Technology Licensing, LLC, Redmond, WA (US)

(72) Inventors: Justin James WAGLE, Pacifica, CA (US); Alekhya NANDULA, Oakland, CA (US); Minah KIM, Bellevue, WA (US)

(21) Appl. No.: 17/188,824

(22) Filed: Mar. 1, 2021

(51) Int. Cl. G06F 16/951; G06F 16/953; G06F 40/289

(52) U.S. Cl. CPC G06F 16/951; G06F 16/953; G06F 40/289

(57) ABSTRACT

Systems and methods for identifying flagged content. One computer-based system includes an electronic processor configured to receive one or more websites, each website including a label identifying a flagged category and content, analyze one or more words included in the content of each of the one or more websites, and associate at least one of the one or more words included in the content of each of the one or more websites with the flagged category. The electronic processor is configured to perform, using the at least one of the one or more words, a query within a search engine to obtain one or more second websites, label each of the one or more second websites with the label identifying the flagged category, and update a model with the one or more websites, the one or more second websites, the one or more words, and the associated labels.

### FIELD

Embodiments described herein relate to systems and methods for identifying search terms, and more specifically, for identifying flagged web content. In some instances, the flagged content is “toxic” web content.

### SUMMARY

The use of search engines is common to navigate the World Wide Web (sometimes referred to as the “web” or the “internet”). Users type a query into a search engine to obtain a result set or list of websites associated with the query. For example, performing a search of the word “zoo” may generate a list of websites related to zoos within a driving distance of a known location. The search may also generate a list of animals that may be found in a zoo. It is common to use personal devices, for example, laptop computers and mobile computing devices (e.g., smart phones, tablet computers, etc.) to perform such searches.

Personal devices are almost universal in many societies and used by most population segments, including children. The popularity of personal devices has resulted in an increase in children having access to the internet. The access is often unrestricted. As a result, parents, teachers, and/or other custodians may have a desire to monitor use of a child's personal device and various searches performed within search engines accessed via the child's personal device. In some instances, children may type words or phrases to perform a search related to content in a particular category that is desirable to monitor. For example, it may be desirable to monitor content that is considered “toxic,” such as cyberbullying, drugs, hate speech, mental health, and violence. Accordingly, a system that monitors and provides notifications regarding such searches as they are performed is useful. Additionally, such a system assists custodians in detecting searches they may have missed when checking a search history, and may detect search queries conducted in an incognito, private, or similar mode.

Accordingly, embodiments described herein provide, among other things, systems and methods for identifying specified or flagged content, for example, toxic content. In one instance, a machine learning algorithm is trained to identify toxic search terms and toxic web content associated with the search terms. For example, a set of training websites labelled with an associated toxic category are provided to the machine learning algorithm. The algorithm then discovers additional toxic content by identifying important words within the supplied websites and performing additional searches using the important words as search terms. The algorithm learns recursively by continuing to discover additional websites and toxic content within the websites.

In some embodiments, a computer-based system for identifying toxic web content is provided. The computer-based system includes an electronic processor configured to receive one or more websites, each website including a label identifying a flagged category and content, analyze one or more words included in the content of each of the one or more websites, associate at least one of the one or more words included in the content of each of the one or more websites with the flagged category, perform, using the at least one of the one or more words, a query within a search engine to obtain one or more second websites, label each of the one or more second websites with the label identifying the flagged category, and update a model with the one or more websites, the one or more second websites, the one or more words, and the associated labels.

Another embodiment provides a method for identifying flagged content. The method includes receiving, via an electronic processor, one or more websites, each website including a label identifying a flagged category and content, analyzing, via the electronic processor, one or more words included in the content of each of the one or more websites, associating, via the electronic processor, at least one of the one or more words included in the content of each of the one or more websites with the flagged category, performing, via the electronic processor and using the at least one of the one or more words, a query within a search engine to obtain one or more second websites, labeling, via the electronic processor, each of the one or more second websites with the label identifying the flagged category, and updating, via the electronic processor, a model with the one or more websites, the one or more second websites, the one or more words, and the associated labels.

Another embodiment provides non-transitory computer-readable memory including instructions that, when executed by an electronic processor, perform a set of functions for identifying flagged content. The set of functions includes receiving one or more websites, each website including a label identifying a flagged category and content, analyzing one or more words included in the content of each of the one or more websites, associating at least one of the one or more words included in the content of each of the one or more websites with the flagged category, performing, using the at least one of the one or more words, a query within a search engine to obtain one or more second websites, labeling each of the one or more second websites with the label identifying the flagged category, and updating a model with the one or more websites, the one or more second websites, the one or more words, and the associated labels

### BRIEF DESCRIPTION OF THE DRAWINGS

FIG. 1 is a diagram illustrating a network with monitoring and learning systems, according to some embodiments.

FIGS. 2A-2C illustrate a search query performed by a search engine, according to some embodiments.

FIG. 3 is a diagram illustrating an association between search queries and user profiles, according to some embodiments.

FIG. 4 is a block diagram of a control system for a mobile device, according to some embodiments.

FIG. 5 is a block diagram of a method performed by the mobile device of FIG. 4, according to some embodiments.

FIG. 6 is a block diagram of a method performed by the mobile device of FIG. 4, according to some embodiments.

FIGS. 7A-7B illustrate a user interface displayed by the mobile device of FIG. 4, according to some embodiments.

FIG. 8 is a block diagram of a method performed by the mobile device of FIG. 4, according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not include a transitory, propagating signal. Accordingly, non-transitory computer-readable medium may include, for example, a hard disk, a CD-ROM, an optical storage device, a magnetic storage device, ROM (Read Only Memory), RAM (Random Access Memory), register memory, a processor cache, other memory and storage devices, or combinations thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

Methods described herein may be performed by one processor, a collection of processors located locally on a single device, or a collection of processors located remotely (e.g., in separate devices). Additionally, all or some of the steps presented in each method may be used. In some embodiments, the steps are conducted in a different order.

As noted above, an increasing number of children are exploring the internet unmoderated. Moderation may occur by detecting the use of flagged search terms in a particular category. One example category is “toxic” search terms. Another category is “age appropriate” material that includes topics appropriate for assumed educational and maturity levels of an age group. However, determining which search terms should be considered with a particular category is difficult, and may differ from user to user. Accordingly, a system is needed that monitors search terms and reports terms determined to be within a category, while also providing for individuality between users.

To address these and other issues, embodiments described herein provide, among other things, a system for training a machine learning algorithm to determine flagged search terms. In the examples explained in much of the remainder of the description, terms that are considered to be toxic are the flagged search terms. However, as already mentioned the teachings herein may be applied to other categories of terms.

By having each device train the algorithm separately, users may experience unique identification of toxic search terms and can personalize identification of terms based on characteristics of their monitored children, such as their age. Additionally, a parent may personalize the machine learning algorithm by providing feedback on their child's flagged search queries. Storing the machine learning algorithm on the parent's local device further maintains a level of privacy not found when stored on a company server.

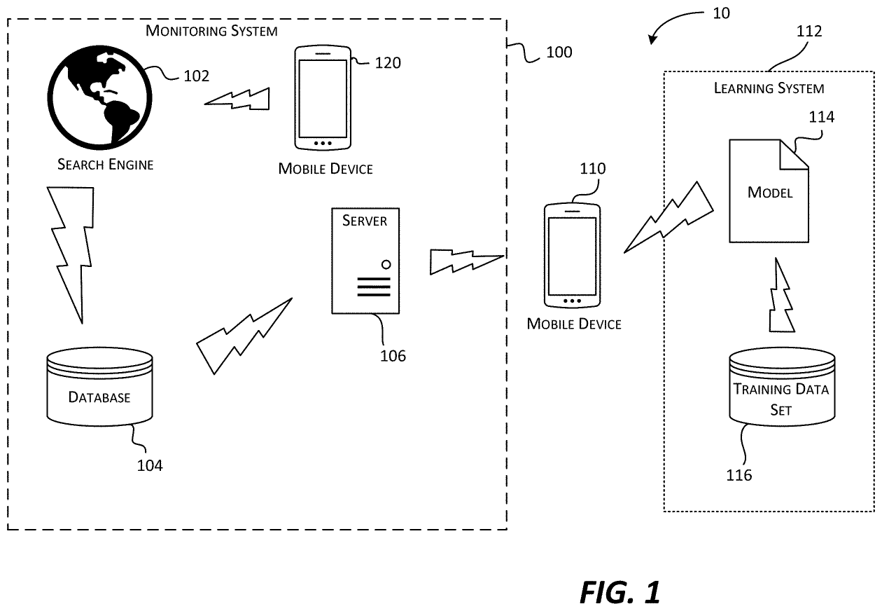

FIG. 1 is a diagram of a network system 10 including monitoring and learning systems communicating with a user device according to some embodiments. In the example illustrated in FIG. 1, the network system 10 includes a monitoring system 100, a learning system 112, and a primary mobile device 110 (e.g., a reporting system). The primary mobile device 110 may be, for example, a desktop computer, a personal laptop, a cellular device, a smart phone, a tablet computer, or the like.

The monitoring system 100 may include, for example, a secondary mobile device 120, a search engine 102, a database 104, and a server 106. The search engine 102 is a software configured to perform web or similar searches. The search engine 102 may be a global search engine, such as Yahoo Search™, Bing™, Google Search™, or the like. Searches performed within a global search query result in websites, which themselves are a series of web pages. In some embodiments, the search engine 102 is a local search engine. A local search engine performs searches within a website itself. For example, searches within the Amazon.com website provide results with various products to purchase within the website.

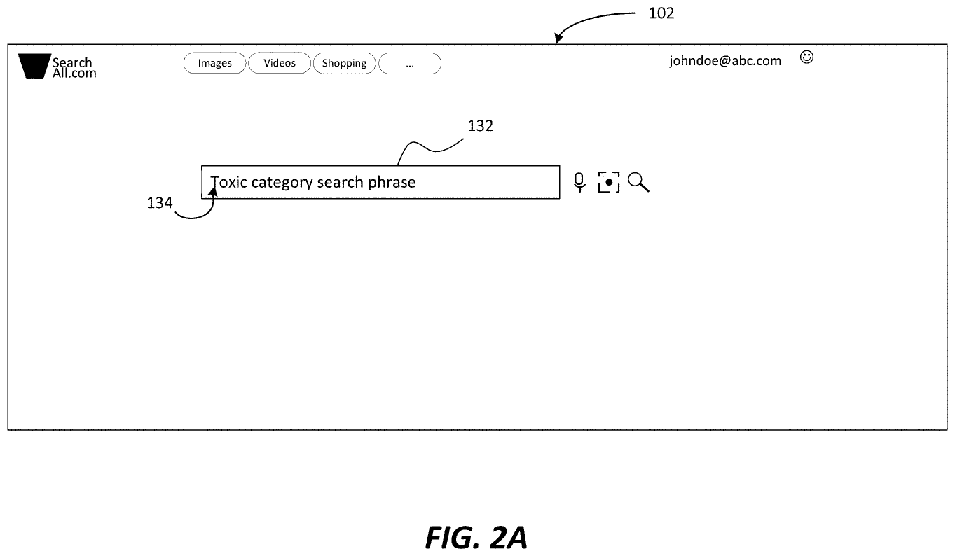

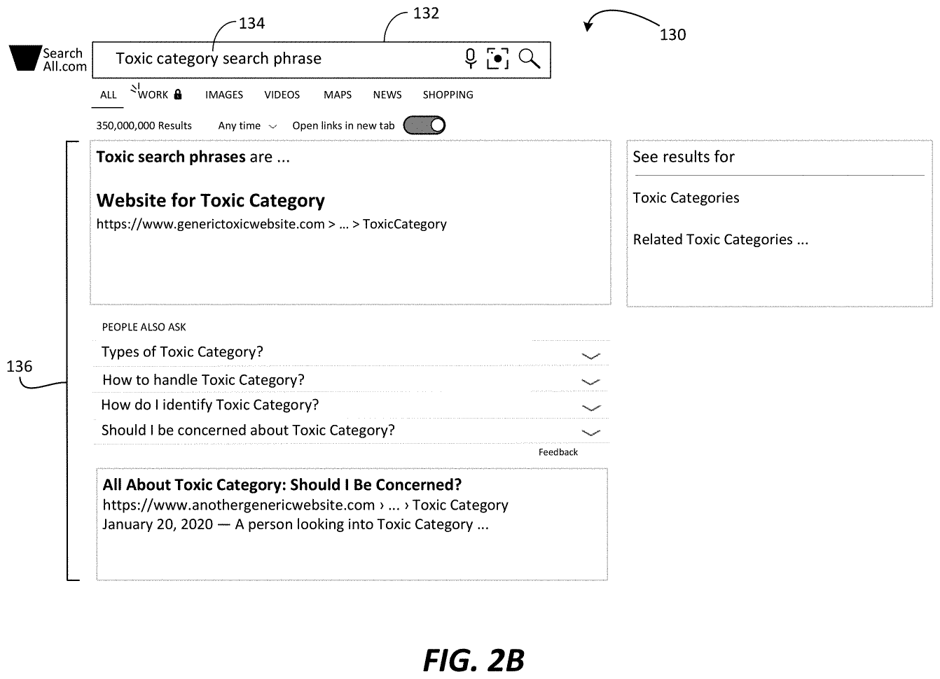

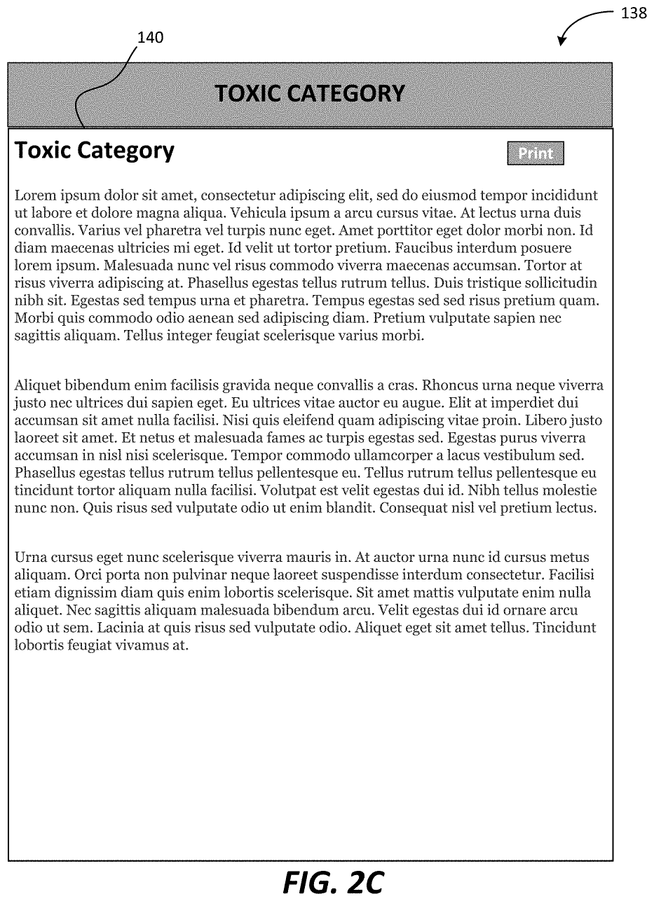

FIG. 2A illustrates an example search engine 102. The search engine 102 includes a search box 132 within which a search query may be entered, in this case search query 134. The search query 134 is entered into the search box 132. For example, a user of the search engine 102 types the search query 134 into the search box 132. FIG. 2B illustrates an example results page 130 resulting from performing a search using the search engine 102. The results page 130 includes the search box 132 containing the search query 134, and a plurality of results 136 in the form of hyperlinks to websites. Conducting the search query results in the results 136. Each of the results 136 is associated with the search query 134. Selection of one of the hyperlinks in the results causes the browser (not shown) running on the device to navigate to the resulting webpage, such as webpage 138 of FIG. 2C. The webpage 138 includes content 140, which may include words, phrases, images, videos, or other items.

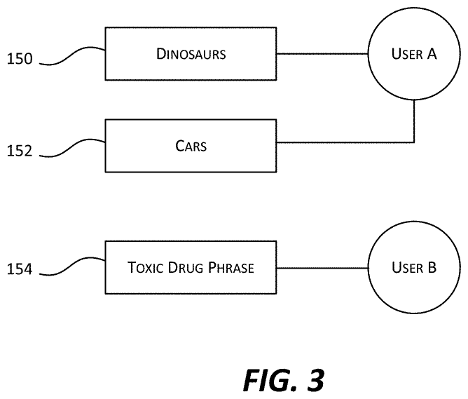

Returning to FIG. 1, the database 104 is configured to store data related to the search engine 102. For example, the search engine 102 may provide the database 104 with search queries performed by the secondary mobile device 120. In some embodiments, the database 104 includes a table that stores an association between the search query performed by the secondary mobile device 120 and a user profile on the secondary mobile device 120. For example, the secondary mobile device 120 may be a tablet computer that is shared by two siblings. Each sibling has their own profile that they access every time they use the tablet (e.g., User A and User B). As shown in FIG. 3, searches performed by User A are linked to the User A profile, and searches performed by User B are linked to the User B profile. Specifically, a first query 150 and a second query 152 are associated with User A, and a third query 154 is associated with User B. In some embodiments, multiple devices in a single household may be connected through a local area network (LAN). For example, in an embodiment where the monitoring system 100 includes a plurality of secondary mobile devices 120, the database 104 may associate received search queries with the respective secondary mobile device 120 on which the search query was performed, and further into which user profile on the secondary mobile device 120 performed said search query.

The server 106 is configured to receive data stored in the database 104 and provide the data to the primary mobile device 110. In this way, the server 106 may act as a backend service to provide information used by the primary mobile device 110. The primary mobile device 110 may then request and/or receive the data stored in the database 104 from the server 106, such as a search query history of the secondary mobile device 120.

The learning system 112 includes a model 114 and a training data set 116. The training data set 116 may include, for example, one or more websites and one or more search queries labelled with a flagged category. The flagged category may include content that is monitored, and may include a toxic category (e.g., a category that includes content considered to be toxic). Toxic categories include, among other things, “adult,” “cyberbullying,” “drugs,” “mental health,” “hate speech,” and “violence.” Additionally, search queries may include words or phrases related to these toxic categories, as described in more detail below. In some embodiments, specific content of the one or more websites may be included in the training data set 116, where the specific content includes a toxic category label. For example, a comment section may be included identifying toxic content.

The training data set 116 receives the model 114 to “learn” how to identify content in the flagged category. For example, the model 114 “learns” what constitutes “toxic” web content. This may be accomplished by receiving a set of embeddings, where each number in the embedding is mapped to a word in the vocabulary. The output of the model using the embeddings may be a value between 0 and 1 (e.g., a toxicity value), where 0 is the least toxic a word is considered, and 1 is the most toxic a word can be considered. Embeddings may further be broken into unigrams and bigrams such that both individual words and complete and/or partial phrases are analyzed. Based on the training data set 116 and the output toxicity value, the model 114 may determine a set of rules (e.g., one or more rules) outlining how to label new websites. The model 114 may be, for example, a convolutional neural network (CNN), a deep feed-forward (DFF) network, a recurrent neural network (RNN), or the like. In some embodiments, a bigram (e.g., analysis of two words at a time), a unigram (e.g., an analysis of one word at a time), or some combination thereof is used.

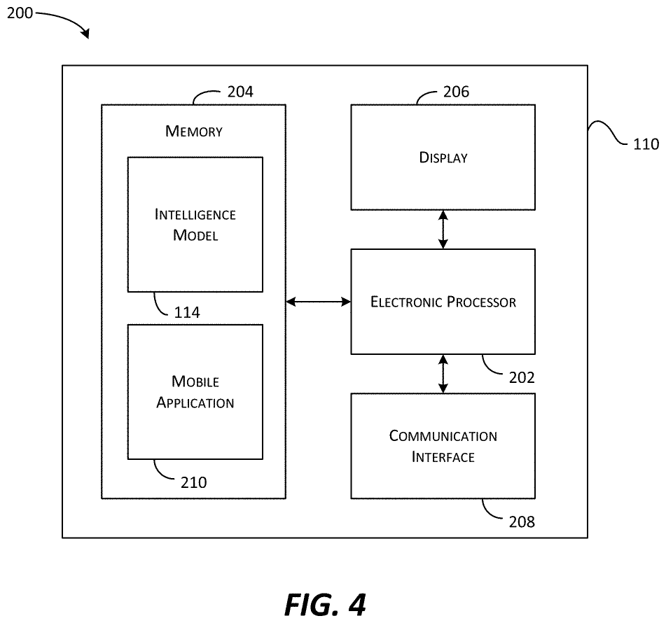

The primary mobile device 110 receives both search queries from the secondary mobile device 120 (through the database 104), and the model 114 from the learning system 112. FIG. 4 provides a block diagram illustrating a control system 200 for controlling operation of the primary mobile device 110. The control system 200 includes an electronic processor 202 (e.g., a microprocessor, an electronic controller, a microcontroller, or another suitable programmable device), a memory 204, a display 206, and a communication interface 208. In some embodiments, the control system 200 includes additional, fewer, or different components.

The memory 204 is a non-transitory computer readable medium and includes, for example, the model 114 and a mobile application 210. The memory 204 can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The electronic processor 202 is connected to the memory 204 and executes software instructions that are capable of being stored in RAM of the memory 204 (e.g., during execution), ROM of the memory 204 (e.g., on a generally permanent basis), or another non-transitory computer readable medium such as another memory or a disc. The electronic processor 202 is configured to retrieve the model 114 and the mobile application 210 from the memory 204 and execute, among other things, instructions related to operations and methods described herein.

The electronic processor 202 may output data regarding search queries and flagged content via the display 206. Additionally, in some embodiments, the display 206 may be a touch-screen, or another display capable of receiving input. A user interface of the mobile application 210 may be provided on the display 206. In some embodiments, the communication interface 208 works in conjunction with the display 206 to provide a user of the primary mobile device 110 with information and receive inputs from the user of the primary mobile device 110. The electronic processor 202 may further communicate (e.g., send and receive data) with components of the monitoring system 100, such as the server 106, using the communication interface 208.

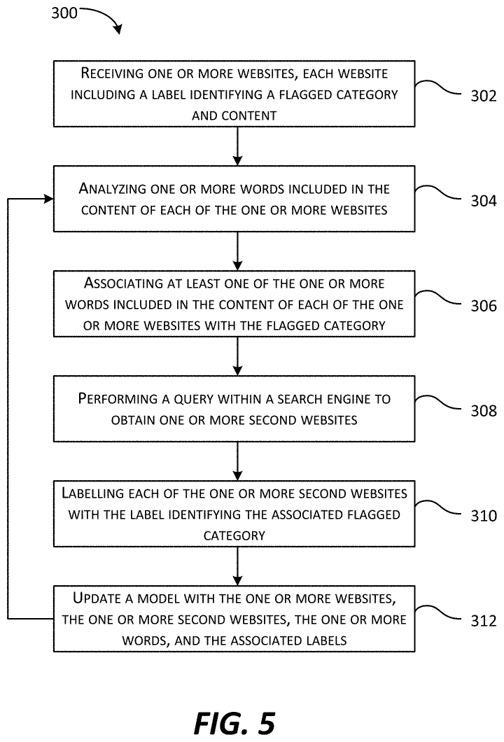

As stated above, the training data set 116 is provided to the model 114. The model 114 creates an initial process for identifying flagged web content based on the training data set 116. However, additional training of the model 114 may be provided by recursively discovering additional websites and associated flagged web content. For example, FIG. 5 illustrates a method 300 for identifying flagged web content. Method 300 may be performed by the electronic processor 202, the learning system 112, an electronic processor of the secondary mobile device 120, or a combination thereof.

At block 302, the electronic processor 202 receives one or more websites. Each website includes a label identifying a flagged category and a content. For example, the training data set 116 includes a plurality of websites. Each website of the plurality of websites includes content, for example, text, words, images, and audio content. Additionally, each website includes a label that associates the respective website with a flagged category, such as a toxic category as described above. The label may be, for example, a file containing all of the website content that associates the content with the toxic category.

At block 304, the electronic processor 202 analyzes one or more words included in the content of each of the one or more websites. For example, the electronic processor 202 may perform a term frequency-inverse document frequency (TF-IDF) analysis on each of the one or more websites. By performing such an analysis, the electronic processor 202 identifies the most important words included in the content of each website. The most important words included in the content of each website may be provided in a list. The electronic processor 202 may prioritize the words based on a determined flagged value and/or their relationship with surrounding words. For example, a user enters the phrase “How to perform action related to mental health.” The electronic processor 202 analyzes the search query and determines the flagged value (e.g., a numerical value) for each word indicative of the importance of the word within the sentence. The flagged value may be stored within a table associating the word with the value. Such a table may be stored in the memory 204, incorporated in the model 114, incorporated in the database 104, or located elsewhere. After determining the flagged value, the electronic processor 202 then determines “mental health” has the highest priority.

The electronic processor 202 may account for the relationship between each phrase or search query, and words within the phrase or search query when identifying the most important words. In some embodiments, the one or more words included in the content of each of the one or more websites is analyzed using word vector embedding. Specifically, each word included in the one or more words is mapped as a word vector in a predefined vector space. The model 114 uses the word vector to determine other similar words that have a similar definition or meaning. In some embodiments, the model 114 further accounts for each word surrounding the respective word being analyzed as the word vector to account for contextual meaning, such as via an embedding layer method. The model 114 may perform natural language processing methods to account for the importance of words in a phrase, such as using a Word2Vec method, a sent2vec method, a bidirectional encoder representations from transformers (BERT) method, an embeddings from language models (ELMo) method, or the like. This may include determining a word's role in a phrase, such as whether the word is a noun or a verb. A word may also be compared to surrounding words to determine contextual information.

At block 306, the electronic processor 202 associates at least one of the one or more words included in the content of each of the one or more websites with the toxic category. For example, the electronic processor 202 may apply one or more rules gathered based on analysis of the training data set 116 to label each word and/or phrase of the one or more words. In some embodiments, only the words and/or phrases with the highest priority are labeled with a toxic category. For example, the numerical statistic for each word and/or phrase is compared to a priority threshold. The words and/or phrases with a numerical statistic above the priority threshold are labelled with a toxic category. The word and/or phrases with a numerical statistic below the priority threshold are not labelled with a toxic category. In some embodiments, the one or more words are labeled with the same toxic category as the corresponding website.

At block 308, the electronic processor 202 performs a query within a search engine to obtain one or more second websites. For example, the electronic processor 202 performs a query within the search engine 102 using the one or more words from block 306. The electronic processor 202 then obtains one or more second websites based on the one or more words used to perform the query. In some embodiments, the one or more words used to perform the query are the prioritized words labeled with the toxic category. At block 310, the electronic processor 202 labels each of the one or more second websites with the label identifying the associated toxic category. For example, the websites resulting from the query are associated with the same toxic category as the one or more websites initially gathered in block 302 and the one or more words used to perform the query in block 306 and block 308.

At block 312, the electronic processor 202 updates the model 114 the one or more websites, the one or more second websites, the one or more words, and the associated labels for each. For example, the one or more rules are updated to account for the one or more second websites uncovered by the query performed in block 308. In some embodiments, the electronic processor 202 returns to block 304 and analyzes one or more words included in the content of each of the one or more second websites uncovered by the query of block 308. In this manner, the electronic processor 202 recursively continues to discover additional websites to use in training the model 114.

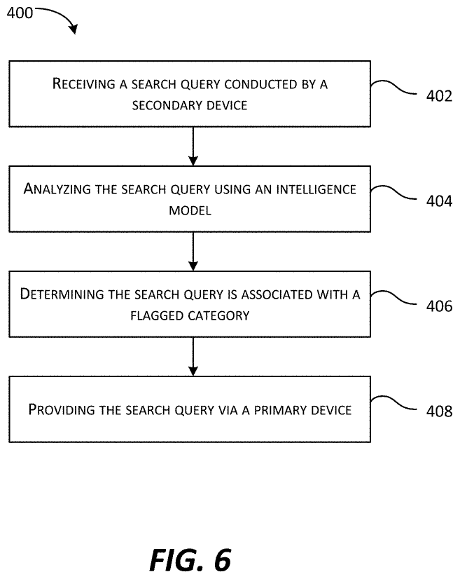

The model 114 is used by the electronic processor 202 to identify flagged content. For example, FIG. 6 provides a method 400 for identifying flagged content within a search query performed by the secondary mobile device 120. In some embodiments, method 400 may be performed by the electronic processor 202, the learning system 112, an electronic processor of the secondary mobile device 120, or a combination thereof.

At block 402, the electronic processor 202 receives a search query conducted by the secondary mobile device 120. For example, the server 106 provides the primary mobile device 110 with a search query stored in the database 104. The server 106 may provide the primary mobile device 110 with the search query when the search query is conducted by the secondary mobile device 120, after a predetermined period of time has passed since the search query was conducted by the secondary mobile device 120, or upon request by the primary mobile device 110.

At block 404, the electronic processor 202 analyzes the search query using the model 114. For example, the one or more rules are applied to the search query. At block 406, the electronic processor 202 determines the search query is associated with a flagged category, such as a toxic category.

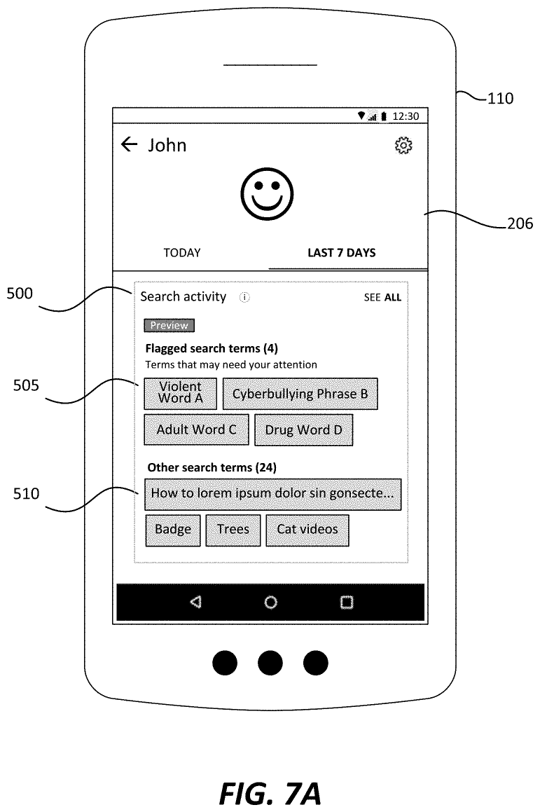

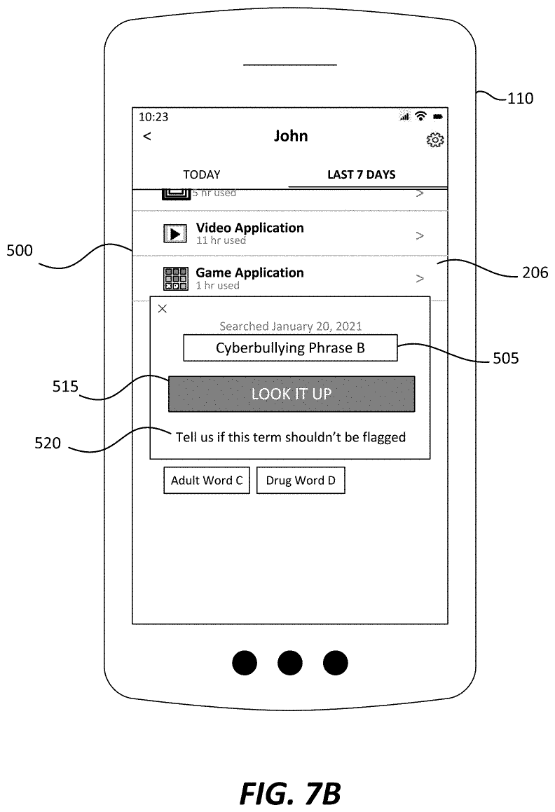

At block 408, the electronic processor 202 provides the search query via the primary mobile device 110. For example, the search query is provided via the display 206. FIG. 7A provides the primary mobile device 110 displaying one or more search queries according to some embodiments. As shown in FIG. 7A, the display 206 displays, via a user interface 500, one or more flagged search terms 505 (e.g., toxic search terms) and one or more non-flagged search terms 510 (e.g., non-toxic search terms). Each of the one or more flagged search terms 505 may be a search query that is associated with a toxic category. In other instances, the one or more non-flagged search terms 510 may be a search query that is not associated with a toxic category. In some embodiments, each of the one or more flagged search terms 505 and the one or more non-flagged search terms 510 are hyperlinks. For example, a user of the primary mobile device 110 may select one or the one or more flagged search terms 505. When one of the one or more flagged search terms 505 is selected, the primary mobile device 110 may provide the associated toxic category of the respective flagged search term 505.

FIG. 7B provides the primary mobile device 110 when one of the one or more flagged search terms 505 is selected according to one embodiment. The electronic processor 202 generates a user interface 500 via display 206. Upon selection of one of the flagged search terms 505, the electronic processor 202 displays, via the display 206, the one of the flagged search terms 505 that has been selected, a look-up button 515, and a feedback button 520. In one example, selection of the look-up button 515 results in a search query being performed within the search engine 102 using the one of the flagged search terms 505 that has been selected. In some embodiments, the websites resulting from the search query triggered by the look-up button 515 are further analyzed to train the model 114, as described within method 300. In the example shown, selection of the feedback button 520 removes the association between the flagged search term 505 and its toxic category. In some embodiments, the model 114 is updated to reflect the removal of the toxic category from the flagged search term 505.

In some embodiments, selection of one of the one or more non-flagged search terms 510 results in the primary mobile device 110 displaying, via the display 206, a similar user interface 500. In such an embodiment, a user of the primary mobile device 110 may provide feedback indicating that the selected one of the non-flagged search terms 510 should be associated with a toxic category. Additionally, the user of the primary mobile device 110 may also provide a selection of the toxic category, resulting in the selected one of the non-flagged search terms 510 being labeled with the selected toxic category.

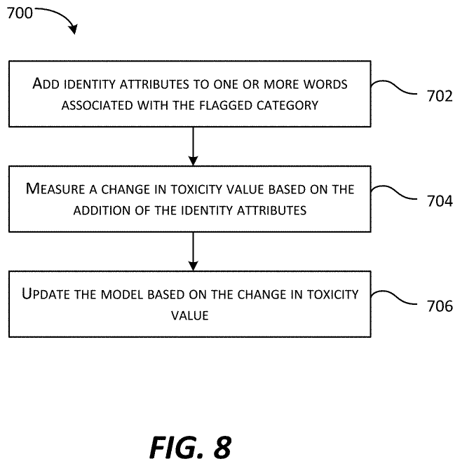

In some instances, the model 114 may exhibit bias towards certain identities, such as words related to gender identities, sexual orientation, race, or the like. This bias may skew analysis of search queries by the model 114. Accordingly, in some embodiments, bias training is conducted on the model 114. FIG. 8 provides a method 700 for removing biases of the model 114. Method 700 may be performed by the electronic processor 202, the learning system 112, an electronic processor of the secondary mobile device 120, or a combination thereof.

At block 702, the electronic processor 202 adds identity attributes to one or more words associated with the flagged category. For example, the trained model 114 includes words, phrases websites, and search queries associated with corresponding toxic categories. Each of the words and/or phrases associated with toxic categories may include a toxicity value indicative of how toxic the word and/or phrase is considered by the model 114. The toxicity value may be, for example, a numerical value between 0 and 10 (0 being not toxic and 10 being highly toxic), a percentage value between 0% and 100% (0% being not toxic and 100% being highly toxic), and the like. An identity attribute is added to each of the words and/or phrases. Identity attributes may be, for example, a word describing a sexual identity, a gender identity, a racial identity, or other similar identity characteristic.

At block 704, the electronic processor 202 measures a change in the toxicity value based on the addition of the identity attributes. For example, the addition of a bias word to another word or phrase may increase the toxicity value from 10% to 30%. In some embodiments, the addition of the identity attribute may change the toxicity value only a small amount (for example, from 10% to 12%). At block 706, the electronic processor 202 updates the model 114 based on a change in the toxicity value for each word. For example, the change in the toxicity value may be compared against a toxicity threshold. If the change in the toxicity value is greater than the threshold, the model 114 is updated such that the identity attribute that resulted in the change in the toxicity value is has its own toxicity value reduced. In this manner, the identity attribute will be considered less toxic by the model 114. If the change in the toxicity value is less than the threshold, no action may be taken.

Accordingly, embodiments described herein provide systems and methods for identifying toxic web content. Various features and advantages of some embodiments are set forth in the following claims.

What is claimed is:

1. A computer-based system for identifying flagged content, the computer-based system comprising:
an electronic processor configured to:
receive one or more websites, each website including a label identifying a flagged category and content;
analyze one or more words included in the content of each of the one or more websites;
associate at least one of the one or more words included in the content of each of the one or more websites with the flagged category;
perform, using the at least one of the one or more words, a query within a search engine to obtain one or more second websites;
label each of the one or more second websites with the label identifying the flagged category; and
update a model with the one or more websites, the one or more second websites, the one or more words, and the associated labels.

2. The computer-based system of claim 1, wherein analyzing one or more words included in the content of each of the one or more websites includes performing a term frequency-inverse document frequency analysis on each of the one or more websites.

3. The computer-based system of claim 1, wherein the electronic processor is further configured to:
perform word vector embedding on the one or more first words to obtain one or more second words similar to the one or more first words; and
perform, using the one or more second words, a second query within the search engine to obtain one or more third websites.

4. The computer-based system of claim 1, wherein labeling each of the one or more second websites with the label identifying the flagged category is performed using a convolutional neural network.

5. The computer-based system of claim 1, wherein the electronic processor is further configured to:
add identity attributes to one or more words associated with the flagged category;
measure a change in a toxicity value of each of the one or more words based on adding the identity attributes; and
update the model based on a change in the toxicity value for each word.

6. The computer-based system of claim 1, wherein the electronic processor is further configured to:
receive a second query conducted by a secondary mobile device, the second query including one or more second words;
analyze the one or more second words included in the second query using the model;
determine whether the one or more second words included in the second query are associated with a second flagged category; and
provide the second query via a display coupled to the electronic processor.

7. The computer-based system of claim 1, wherein the flagged category includes at least one selected from a group consisting of adult, cyberbullying, drugs, mental health, hate speech, and violence.

8. A method for identifying flagged content, the method comprising:
receiving, via an electronic processor, one or more websites, each website including a label identifying a flagged category and content;
analyzing, via the electronic processor, one or more words included in the content of each of the one or more websites;
associating, via the electronic processor, at least one of the one or more words included in the content of each of the one or more websites with the flagged category;
performing, via the electronic processor and using the at least one of the one or more words, a query within a search engine to obtain one or more second websites;
labeling, via the electronic processor, each of the one or more second websites with the label identifying the flagged category; and
updating, via the electronic processor, a model with the one or more websites, the one or more second websites, the one or more words, and the associated labels.

9. The method of claim 8, wherein analyzing one or more words included in the content of each of the one or more websites includes performing a term frequency-inverse document frequency analysis on each of the one or more websites.

10. The method of claim 8, further comprising:
performing, via the electronic processor, word vector embedding on the one or more first words to obtain one or more second words similar to the one or more first words; and
performing, via the electronic processor and using the one or more second words, a second query within the search engine to obtain one or more third websites.

11. The method of claim 8, wherein labeling each of the one or more second websites with the label identifying the flagged category is performed using a convolutional neural network.

12. The method of claim 8, further comprising:
adding, via the electronic processor, identity attributes to one or more words associated with the flagged category;
measuring, via the electronic processor, a change in a toxicity value of each of the one or more words based on adding the identity attributes; and
updating, via the electronic processor, the model based on the change in the toxicity value for each word.

13. The method of claim 8, further comprising:
receiving, via the electronic processor, a second query conducted by a secondary mobile device, the second query including one or more second words;
analyzing, via the electronic processor, the one or more second words included in the second query using the model;
determining, via the electronic processor, whether the one or more second words included in the second query are associated with a second flagged category; and
providing, via the electronic processor, the second query via a display coupled to the electronic processor.

14. The method of claim 8, wherein the flagged category includes at least one selected from a group consisting of adult, cyberbullying, drugs, mental health, hate speech, and violence.

15. Non-transitory computer-readable memory including instructions that, when executed by an electronic processor, perform a set of functions for identifying flagged content, the set of functions comprising:
receiving one or more websites, each website including a label identifying a flagged category and content;
analyzing one or more words included in the content of each of the one or more websites;
associating at least one of the one or more words included in the content of each of the one or more websites with the flagged category;
performing, using the at least one of the one or more words, a query within a search engine to obtain one or more second websites;
labeling each of the one or more second websites with the label identifying the flagged category; and
updating a model with the one or more websites, the one or more second websites, the one or more words, and the associated labels.

16. The set of functions of claim 15, wherein analyzing one or more words included in the content of each of the one or more websites includes performing a term frequency-inverse document frequency analysis on each of the one or more websites.

17. The set of functions of claim 15, further comprising:
performing word vector embedding on the one or more first words to obtain one or more second words similar to the one or more first words; and
performing, using the one or more second words, a second query within the search engine to obtain one or more third websites.

18. The set of functions of claim 15, wherein labeling each of the one or more second websites with the label identifying the flagged category is performed using a convolutional neural network.

19. The set of functions of claim 15, further comprising:
adding identity attributes to one or more words associated with the flagged category;
measuring a change in a toxicity value of each of the one or more words based on adding the identity attributes; and
updating the model based on the change in the toxicity value for each word.

20. The set of functions of claim 15, further comprising:
receiving a second query conducted by a secondary mobile device, the second query including one or more second words;
analyzing the one or more second words included in the second query using the model;
determining whether the one or more second words included in the second query are associated with a second flagged category; and
providing the second query via a display coupled to the electronic processor.
